(19) United States
(12) Patent Application Publication
(10) Pub. No.: US 2024/0189753 A1
(43) Pub. Date: Jun. 13, 2024

(54) REMOVABLE FLUE GAS STRAINER AND ASSOCIATED METHODS

(71) Applicant: MARATHON PETROLEUM COMPANY LP, Findlay, OH (US)

(72) Inventors: Michael Esquivel, Findlay, OH (US); Ethan Spielvogel, Findlay, OH (US)

(21) Appl. No.: 18/142,111

(22) Filed: May 2, 2023

Related U.S. Application Data
(60) Provisional application No. 63/386,586, filed on Dec. 8, 2022.

(51) Int. Cl. B01D 46/16; B01D 46/00; B01D 46/62; B01D 46/66; B08B 17/02

(52) U.S. Cl. CPC B01D 46/16; B01D 46/0005; B01D 46/62; B01D 46/66; B08B 17/02; B01D 2265/025; B01D 2271/027; B01D 2273/14

(57) ABSTRACT

Apparatuses, systems, and methods operable to reduce catalyst fouling by removing solid particulates from a heated fluid stream upstream of a catalyst using one or more flue gas strainer apparatuses that may be cleaned or serviced without ceasing or disrupting heating or catalytic operations. The flue gas strainer apparatuses may include a housing having a front end and a back end, the housing comprising a receiving portion, an outer edge, an inner edge, and an inner bore extending from the front end to the back end of the housing along the inner edge. The inner bore is operable to allow a heated fluid stream to pass therethrough. The flue gas strainer apparatus may also include a moveable strainer portion comprising one or more removable mesh portions. Each of the one or more removable mesh portions may have a plurality of pores and configured to capture solid particulates suspended in the heated fluid stream. The one or more removable mesh portions may be operable to be removingly received in the receiving portion of the housing.

### CROSS-REFERENCE TO RELATED APPLICATIONS

This application claims priority to, and the benefit of, U.S. Provisional Application No. 63/386,586, filed Dec. 8, 2022, titled “Removable Flue Gas Strainer and Associated Methods,” the disclosure of which is incorporated herein by reference in its entirety.

### TECHNICAL FIELD

The present disclosure generally relates to apparatuses, systems, and methods for removing solid particulates from a fluid stream upstream of a catalyst. More specifically, the present disclosure relates to, among other embodiments, apparatuses, systems and methods for removing heating element-derived fiber and dust particles from heated fluid streams to reduce risk or prevent the fouling of downstream catalysts and equipment such as by the solid particulates.

### BACKGROUND

Many industrial processes involve the use of heaters and boilers to heat chemical components of fluid streams upstream of an environmental catalyst. Often, industrial equipment employed upstream of an environmental catalyst, including heating elements used in process heaters and boilers, shed fibers and dust particles that may disrupt downstream catalysts and equipment. This may be particularly true when heating elements having fiber refractories are used. In such instances, fibers and other solid particulates from the heating element may lay down on the catalyst face or otherwise foul downstream catalysts and other equipment causing unplanned unit shutdowns and lost profits. Accordingly, Applicant has recognized that apparatuses, methods, and systems for preventing the fouling of downstream catalysts without shutting down industrial process streams are desirable.

### SUMMARY

To address these shortcomings, Applicant has developed apparatuses, systems, and methods for mitigating catalyst fouling to allow the process plants or streams to continue to operate smoothly or without the need for shutting down industrial process plants or streams. In particular, embodiments of the presently disclosed apparatuses, systems, and methods are operable to reduce catalyst fouling by removing solid particulates from a heated fluid stream upstream of a catalyst by use of one or more removable flue gas strainers, for example, that may be cleaned or serviced without ceasing or disrupting the heating or catalytic operations. In certain embodiments, the presently disclosed apparatuses, systems, and methods may be used to protect catalysts used in fluid catalytic cracking (FCC) units. In particular, in certain embodiments, one or more of the presently disclosed flue gas strainer apparatuses may be installed in flue gas ducting upstream of one or more fluid catalytic cracking (FCC) units.

Embodiments of a flue gas strainer apparatus for removing solid particulates from a heated fluid stream upstream of a catalyst also are provided. In certain embodiments, the flue gas strainer apparatus may include a housing having a front end and a back end. The housing may also include a receiving portion, an outer edge, an inner edge, and an inner bore extending from the front end to the back end of the housing along the inner edge. The inner bore may be operable to allow a heated fluid stream to pass therethrough. The removable flue gas strainer may also include a moveable strainer portion having one or more removable mesh portions. Each of the one or more removable mesh portions may include a plurality of pores and may be configured to capture solid particulates suspended in the heated fluid stream while providing pores for allowing the heated fluid stream to pass therethrough. The one or more removable mesh portions may be operable to be removingly received in the receiving portion of the housing such that in a first received configuration, the one or more removable mesh portions are operable to capture solid particulates suspended in the heated fluid stream passing through the inner bore of the housing. In a second retracted configuration, the one or more removable mesh portions are operable to be retracted such that the mesh portion is outside the inner bore of the housing and operable to be cleaned of captured solid particulates while the heated fluid stream continues to flow through the inner bore of the housing.

In certain embodiments, the flue gas strainer apparatus is configured to be positioned in a heated fluid stream such that the outer edge of the housing sealingly engages a duct containing the heated fluid stream. In certain embodiments, the outer edge of the housing has one or more flanges operable to sealingly engage the duct containing the heated fluid stream.

In certain embodiments of the flue gas strainer apparatus, the receiving portion of the housing may be disposed between a front end and a back end of the housing. In some embodiments, for example, the receiving portion may comprise a slot in the housing disposed between the front end and the back end of the housing. In certain embodiments, the flue gas strainer apparatus may include a means for moving or retracting the moveable strainer portion. In such embodiments, the means for moving or retracting the moveable strainer portion may include a motor coupled to a tether that is coupled to the moveable strainer portion. In certain embodiments, the flue gas strainer apparatus may further include one or more sealing elements operable to form a seal around the moveable strainer portion and/or the one or more removable mesh portions once received in the receiving portion.

In certain embodiments of the flue gas strainer apparatus, the moveable strainer portion may be operable to retract or otherwise move such that the one or more removable mesh portions are remove from the heated fluid stream so that the one or more mesh portions may be cleaned of captured solid particulates without disrupting the heated fluid stream flowing through the inner bore or disrupting one or more industrial operations relying on the flow of the heated fluid stream. In certain embodiments, the flue gas strainer apparatus may further include a means for moving or advancing the moveable strainer portion such that the one or more mesh portions of the moveable strainer portion are inserted into the inner bore of the housing from a position outside the inner bore of the housing.

In certain embodiments, the moveable strainer portion of the flue gas strainer apparatus may include a support frame coupling the one or more mesh portions to the means for moving the moveable strainer portion. The support frame may be coupled to one or more edges of the one or more mesh portions.

In certain embodiments, the moveable strainer portion comprises a plurality of removable mesh portions. In some instances, the plurality of removable mesh portions may be coupled together by the support frame. In certain embodiments, the removable mesh portions may be spaced apart on the support frame and/or the moveable strainer portion such that when at least one mesh portion is inserted into the inner bore of the housing, at least one other mesh portion is positioned outside the inner bore of the housing. In certain embodiments, the means for moving the moveable strainer portion may further comprise a means for rotating the plurality of mesh portions into and out of the inner bore of the housing such that when a fouled mesh portion comprising captured particles is removed from the inner bore of the housing, a clean mesh portion is inserted into the inner bore of the same housing by the same motion of the moveable strainer portion.

A method of reacting a heated fluid stream with a catalytic reactor also is provided, according to certain embodiments of the present disclosure. In certain embodiments, the method may include providing one or more flue gas strainer apparatuses positioned in a flowpath of a heated fluid stream between one or more heating elements and one or more catalytic reactors. The one or more flue gas strainer apparatuses, for example, may include a housing having an inner bore operable to receive the heated fluid stream therethrough and a moveable strainer portion that includes one or more removable mesh portions. The one or more removable mesh portions may have a plurality of pores and be configured to capture solid particulates suspended in the heated fluid stream. The method also may include causing the capture of solid particulates suspended in the heated fluid stream on or about the one or more removable mesh portions of the one or more flue gas strainer apparatuses. The method may also include removing or retracting the one or more removable mesh portions from the flowpath of the heated fluid stream without disrupting the flow of the heated fluid stream through the inner bore. The method may further include cleaning the one or more removable mesh portions of the moveable strainer portion to substantially remove the captured solid particulates, and re-inserting the one or more removable mesh portions into the flowpath of the heated fluid stream.

In certain embodiments, the one or more flue gas strainer apparatuses employed in the method may include a first flue gas strainer apparatus and a second flue gas strainer apparatus. The first and second flue gas strainer apparatuses may be arranged in series and operable to be deployed in a first received configuration and a second retracted configuration. For example, in a first received configuration, at least one of the on or more removable mesh portions of the moveable strainer portion may be received in the housing and operable to capture solid particulates suspended in the heated fluid stream passing through the inner bore of the housing, and in a second retracted configuration, the at least one of the one or more removable strainer portions may be retracted from the inner bore of the housing and operable to have the mesh portion available to be substantially cleaned of captured solid particulates while the heated fluid stream continues to flow through the inner bore of the housing.

In such embodiments, the method may also include deploying the first flue gas strainer apparatus in the first received configuration so as to cause the capture of solid particulates suspended in the heated fluid stream on or about at least one of the one or more removable mesh portions of the first flue gas strainer apparatus. The method may further include deploying the first flue gas strainer apparatus in the second retracted configuration while the second flue gas strainer apparatus is deployed in the first received configuration. The method may also include cleaning the at least one of the one or more removable mesh portions of the first flue gas strainer apparatus so as to substantially remove the captured solid particulates, and capturing solid particulates on or about the at least one of the one or more removable mesh portions of the second flue gas strainer apparatus substantially contemporaneous with the cleaning of the at least one of the one or more removable mesh portions of the first flue gas strainer apparatus.

In certain embodiments, the method may also include deploying, after substantial removal of the captured solid particulates from the one or more removable mesh portions, the first flue gas strainer apparatus in the first received configuration so as to cause the capture of solid particulates suspended in the heated fluid stream. The method may also include deploying the second flue gas strainer apparatus in the second retracted configuration while the first flue gas strainer apparatus is deployed in the first received configuration. The method may further include cleaning the one or more removable mesh portions of the second flue gas strainer apparatus so as to substantially remove the captured solid particulates, and causing the capture of solid particulates on or about the one or more removable mesh portions of the first flue gas strainer apparatus substantially contemporaneous with the cleaning of the one or more removable mesh portions of the second flue gas strainer apparatus.

In certain embodiments, the method further may include heating a fluid, at the one or more heating elements, to generate a heated fluid stream and supplying the heated fluid stream to one or more flue gas strainer apparatuses to produce a strained heated fluid stream. In this embodiment of the method, the one or more flue gas strainer apparatuses may be operable to remove at least a portion of the solid particulates suspended in the heated fluid stream. The method may further include supplying the strained fluid stream to one or more catalytic reactors to produce a treated fluid gas stream.

In some embodiments, the catalytic reactor used in the method may include a catalyst having an average pore size that is larger than the average pore size of the one or more removable mesh portions of the first and second flue gas strainer apparatuses. The solid particulates removed by the method may, in certain embodiments, be derived from the one or more heating elements. In some instances, the one or more heating elements may include a refractory heating element or a fiber refractory heating element. In some embodiments, the one or more catalytic reactors employed in the method may be part of a fluid catalytic cracking (FCC) unit. In certain embodiments, the heated fluid stream may be a flue gas stream generated by one or more refinery operations.

A system for reacting a heated fluid stream with a catalytic reactor is also provided, according to certain embodiments of the present disclosure. In certain embodiments, the system may include one or more heating elements operable to heat a fluid stream to produce a heated fluid stream. The system may also include one or more catalytic reactors that include a catalyst operable to react with one or more components in the heated fluid stream to produce a treated fluid stream. The system may also include one or more flue gas strainer apparatuses positioned in a flowpath of the heated fluid stream between the one or more heating elements and the one or more catalytic reactors. The one or more flue gas strainer apparatuses are operable to receive the heated fluid stream and capture solid particulates suspended in the heated fluid stream on one or more removable mesh portions. The one or more removable mesh portions are operable to be removed from flowpath of the heated fluid stream in order to be cleaned while the heated fluid stream continues to flow to the or more catalytic reactors.

In certain embodiments, each of the flue gas strainer apparatuses employed in the system may include a housing having a front end and a back end. The housing may also include a receiving portion, an outer edge, an inner edge, and an inner bore extending from the front end to the back end of the housing along the inner edge. The inner edge also may define an inner bore operable to allow the heated fluid stream to pass therethrough. The flue gas strainer apparatus may also include a moveable strainer portion comprising one or more removable mesh portions having a plurality of pores and configured to capture solid particulates suspended in the heated fluid stream. The moveable strainer portion and/or the one or more removable mesh portions contained thereon may be operable to be removingly received in the receiving portion of the housing such that in a first received configuration, the one or more removable mesh portions of the moveable strainer portion is operable to capture solid particulates suspended in the heated fluid stream passing through the inner bore of the housing. In a second retracted configuration, the one or more removable mesh portions are operable to be cleaned of captured solid particulates while the heated fluid stream continues to flow through the inner bore of the housing.

In certain embodiments, the system also may include a first flue gas strainer apparatus and a second flue gas strainer apparatus. In such embodiments, the first and second flue gas strainer apparatuses may be arranged in series and operable to be deployed in a first received configuration and a second retracted configuration. In the first received configuration, the moveable strainer portion and/or the one or more removable mesh portions contained thereon is received in the housing and operable to capture solid particulates suspended in the heated fluid stream passing through the inner bore of the housing. In the second retracted configuration, the moveable strainer portion and/or the one or more removable mesh portions may be retracted from the inner bore of the housing and operable to have the mesh portion available to be substantially cleaned of captured solid particulates while the heated fluid stream continues to flow through the inner bore of the housing. In such embodiments, the first and second flue gas strainer apparatuses may be configured such that the one or more removable mesh portions of a respective one of the flue gas strainer apparatuses may be cleaned outside the flowpath of the heated fluid stream while the one or more removable mesh portions of the other flue gas strainer apparatus is operable to capture solid particulates suspended in the heated fluid stream. As a result, operation of an embodiment of the system may occur continuously without the need to cease operations to clean the one or more removable mesh portions and the one or more removable mesh portions of at least one of the removable flue gas strainer apparatuses may be positioned and operable to capture solid particulates from the heated fluid stream.

In certain embodiments of the system, the one or more removable mesh portions of the one or more flue gas strainer apparatuses includes a plurality of pores having an average pore size smaller than the average pore size of the catalyst used in the catalytic reactor. In at least some embodiments of the system, at least one of the one or more heating elements may be a fiber refractory heating element and at least a portion of the solid particulates is derived from the one or more heating elements. In some embodiments of the system, the heated fluid stream may be a flue gas stream generated by one or more refinery operations.

Still other aspects and advantages of these exemplary embodiments and other embodiments, are discussed in detail herein. Moreover, it is to be understood that both the foregoing information and the following detailed description provide merely illustrative examples of various aspects and embodiments and are intended to provide an overview or framework for understanding the nature and character of the claimed aspects and embodiments. Accordingly, these and other advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to more clearly illustrate embodiments of the disclosure.

FIG. 1 is a graphical representation of a system and method for reacting a heated fluid stream with a catalytic reactor which may employ one or more flue gas strainer apparatuses having one or more removable mesh portions, according to an exemplary embodiment of the present disclosure.

FIG. 2 is a graphical representation of a system and method for reacting a heated fluid stream with a catalytic reactor which may employ one or more flue gas strainer apparatuses having one or more removable mesh portions, according to an exemplary embodiment of the present disclosure.

FIG. 3 is a graphical representation of a system and method for reacting a heated fluid stream with a catalytic reactor which may employ one or more flue gas strainer apparatuses having one or more removable mesh portions, according to an exemplary embodiment of the present disclosure.

FIG. 4 is a schematic representation of a flue gas strainer apparatus for removing solid particulates from a heated fluid stream upstream of a catalyst, shown in a first received configuration, according to an exemplary embodiment of the present disclosure.

FIG. 5 is a schematic representation of a flue gas strainer apparatus for removing solid particulates from a heated fluid stream upstream of a catalyst, shown in a partially retracted configuration, according to an exemplary embodiment of the present disclosure.

FIG. 6 is a schematic representation of a flue gas strainer apparatus for removing solid particulates from a heated fluid stream upstream of a catalyst, shown in a second retracted configuration, according to an exemplary embodiment of the present disclosure.

FIG. 7 is a schematic representation of a dual element flue gas strainer apparatus having two removable mesh portions for removing solid particulates from a heated fluid stream, shown in a first configuration with a first removable mesh portion received in the housing and a second removable mesh portion positioned outside the housing, according to an exemplary embodiment of the present disclosure.

FIG. 8 is a schematic representation of a dual element flue gas strainer apparatus having two removable mesh portions for removing solid particulates from a heated fluid stream, shown in a second configuration with a second removable mesh portion received in the housing and a first removable mesh portion positioned outside the housing, according to an exemplary embodiment of the present disclosure.

FIG. 9 is a schematic representation of a three element flue gas strainer apparatus having three removable mesh portions for removing solid particulates from a heated fluid stream, shown in a first configuration with a first removable mesh portion received in the housing and a second and third removable mesh portions positioned outside the housing, according to an exemplary embodiment of the present disclosure.

FIG. 10 is a schematic representation of a three element flue gas strainer apparatus having three removable mesh portions for removing solid particulates from a heated fluid stream, shown in a second configuration with a third removable mesh portion received in the housing and first and second removable mesh portions positioned outside the housing, according to an exemplary embodiment of the present disclosure.

FIG. 11 is a graphical representation of a flue gas strainer insertion/retraction control system and method for inserting and/or retracting one or more removable mesh portions with respect to a flue gas strainer housing or flue gas ducting, according to an exemplary embodiment of the present disclosure.

FIG. 12 is a flow diagram of controller operations in a flue gas strainer insertion/retraction control system and method for inserting and/or retracting one or more removable mesh portions with respect to a flue gas strainer housing or flue gas ducting, according to an exemplary embodiment of the present disclosure.

### DETAILED DESCRIPTION

The present disclosure describes various embodiments related to apparatuses, systems, and methods for mitigating catalyst fouling to allow the process plants or streams to continue to operate smoothly or without the need for shutting down industrial process plants or streams. Further embodiments may be described and disclosed.

In the following description, numerous details are set forth in order to provide a thorough understanding of the various embodiments. In other instances, well-known processes, devices, and systems may not have been described in particular detail in order not to unnecessarily obscure the various embodiments. Additionally, illustrations of the various embodiments may omit certain features or details in order to not obscure the various embodiments.

The description may use the phrases “in some embodiments,” “in various embodiments,” “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “reducing,” “reduced,” or any variation thereof, when used in the claims and/or the specification includes any measurable decrease or complete inhibition to achieve a desired result.

The use of the words “a” or “an” when used in conjunction with any of the terms “comprising,” “including,” “containing,” or “having,” in the claims or the specification may mean “one,” but it is also consistent with the meaning of “one or more,” “at least one,” and “one or more than one.” The terms “wt. %”, “vol. %”, or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Disclosed herein are apparatuses, systems, devices, and methods for removing solid particulates from a fluid stream upstream of a catalyst or other sensitive equipment, in order to reduce or prevent fouling of the catalyst and other downstream equipment. The presently disclosed apparatuses, systems, devices, and methods are particularly useful for removing heating element-derived fiber and dust particles from heated fluid streams, without necessitating the cessation of industrial operations for cleaning, rehabilitation, or replacement of the catalyst. The presently disclosed systems and methods employ one or more flue gas strainer apparatuses capable of reducing catalyst fouling by removing solid particulates from a heated fluid stream and operable to be cleaned or serviced without ceasing or disrupting heating or catalytic operations, thereby mitigating the need for costly process or system downtime.

FIG. 1 is a graphical representation of a system 100 and method 105 for reacting a heated fluid stream with a catalytic reactor, according to an exemplary embodiment of the present disclosure. As depicted in FIG. 1, system 100 may include a fluid stream (e.g., flue gas stream) 115 that may be generated by an industrial process, including but not limited to, one or more refinery operations 110. Flue gas stream 115 may be heated by one or more heating elements 120 operable to heat a fluid stream to produce as heated fluid stream, such as heated flue gas stream 125, as depicted in FIG. 1. System 100 also includes one or more flue gas strainer apparatuses 130, 140 positioned in the flowpath between the heated fluid stream 125 and one or more catalytic reactors 150. The one or more catalytic reactors 150 may contain a catalyst or catalyst bed operable to react with one or more components in the heated fluid stream 125 to produce a treated fluid stream 155. In some embodiments, the one or more catalytic reactors 150 employed in system 100 and method 105 may be part of a fluid catalytic cracking (FCC) unit.

Flue gas strainer apparatuses 130, 140 may be operable to receive the heated fluid stream 125 produced by heating element 120 and capture solid particulates suspended in the heated fluid stream 125 on one or more removable mesh portions of the flue gas strainer apparatus 130, 140. Once solid particulates are captured on the removable mesh portion of flue gas strainer apparatuses 130, 140, the removable mesh portion may be retracted out of the flowpath of the heated fluid stream in order to be cleaned or serviced so as to not foul the performance of the flue gas strainer. The one or more removable mesh portions of flue gas strainer apparatuses 130, 140 may be removed from the flowpath of the heated fluid stream any number of times without causing a stoppage of heating or catalytic operations in system 100.

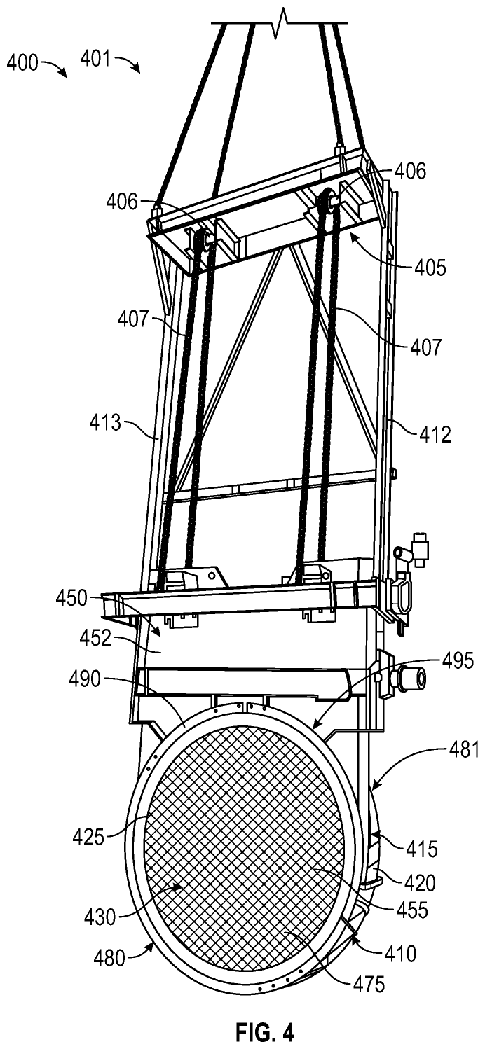

Exemplary embodiments of flue gas strainer apparatuses 130, 140 are provided in FIGS. 4-10.

Flue gas strainer apparatus 400 depicted in FIG. 4 is one of many embodiments of flue gas strainer apparatus that may be employed as flue gas strainer apparatuses 130, 140 in system 100. Other embodiments of flue gas strainer apparatuses are within the spirit and scope of the present disclosure. As shown in FIG. 4, flue gas strainer apparatus 400 may include a housing 410 having a front end 480 and a back end 481. Housing 410 may also have an outer edge 420, an inner edge 425, a receiving portion 415, and an inner bore 430 extending from the front end 480 to the back end 481 of the housing along the inner edge 425. The inner edge 425 of flue gas strainer apparatus 400 may define the inner bore 430 which is operable to allow a heated fluid stream to pass therethrough. Flue gas strainer apparatus 400 also includes a moveable strainer portion 450 that comprises one or more removable mesh portions 455. The one or more removable mesh portions 455 has a plurality of pores 475 and is configured to capture solid particulates suspended in the heated fluid stream.

The flue gas strainer apparatus 400 is configured to be positioned in a heated fluid stream such that the outer edge 420 of housing 410 sealingly engages a duct containing the heated fluid stream. In at least some aspects, the flue gas strainer apparatus 400 may include one or more sealing elements 495 coupled with the outer edge 420 of the housing. The one or more sealing elements 495 may be operable to sealingly engage a conduit or duct containing the heated flue stream or heated flue gas stream. In at least some instances, the one or more sealing elements 495 may include one or more flanges 490 coupled to the outer edge 420 of the housing 410 and operable to sealingly engage the duct containing the heated fluid stream. In addition to flanges 490, other means or mechanisms for the outer edge 420 to sealingly engage the ducting containing the heated fluid stream are within the spirit and scope of the present disclosure.

The moveable strainer portion 450 of flue gas strainer apparatus 400 is operable to retract or otherwise be removed from the heated fluid stream such that the one or more removable mesh portions 455 may be cleaned to remove solid particulates captured on the mesh without disrupting the heated fluid stream flowing through the inner bore 430 of housing 410 or disrupting industrial operations that rely on the flow of the heated fluid stream. Accordingly, the moveable strainer portion 450 and/or the one or more removable mesh portions 455 are operable to be removingly received in the receiving portion 415 of the housing 410 such that, in a first received configuration 401 depicted in FIG. 4, the one or more removable mesh portions of moveable strainer portion 450 are operable to capture solid particulates suspended in the heated fluid stream passing through the inner bore 430 of the housing 410.

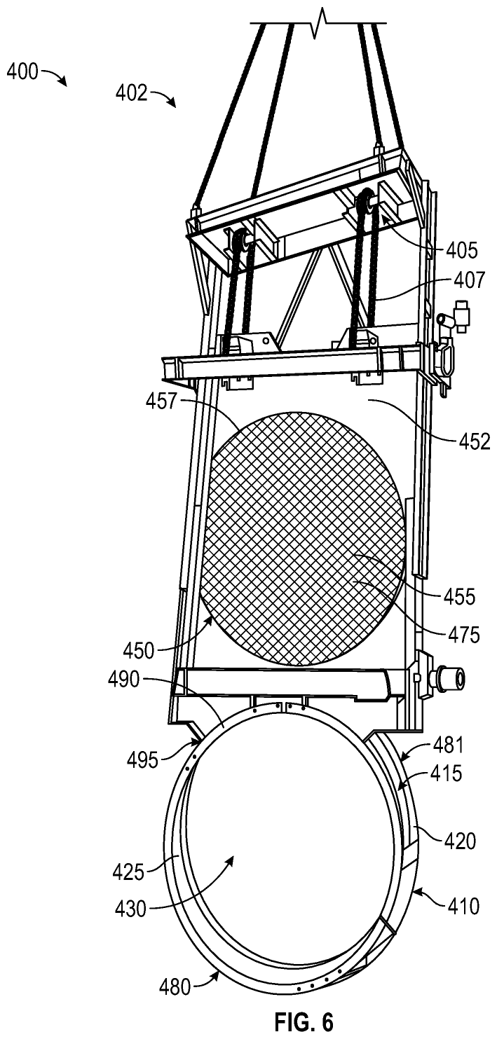

Once the one or more removable mesh portions 455 of moveable strainer portion 450 has captured solid particulates from the heated fluid stream on the mesh portion 455, the moveable strainer portion 450 and/or the one or more removable mesh portions 455 may be retracted from the inner bore 430 of housing 410 by deploying the flue gas strainer apparatus 400 to the second retracted configuration 402 shown in FIG. 6. In the second retracted configuration 402, the one or more removable mesh portions 455 is outside the inner bore 430 of the housing 410 and is operable to be cleaned of captured solid particulates while the heated fluid stream continues to flow through the inner bore 430 of the housing 410.

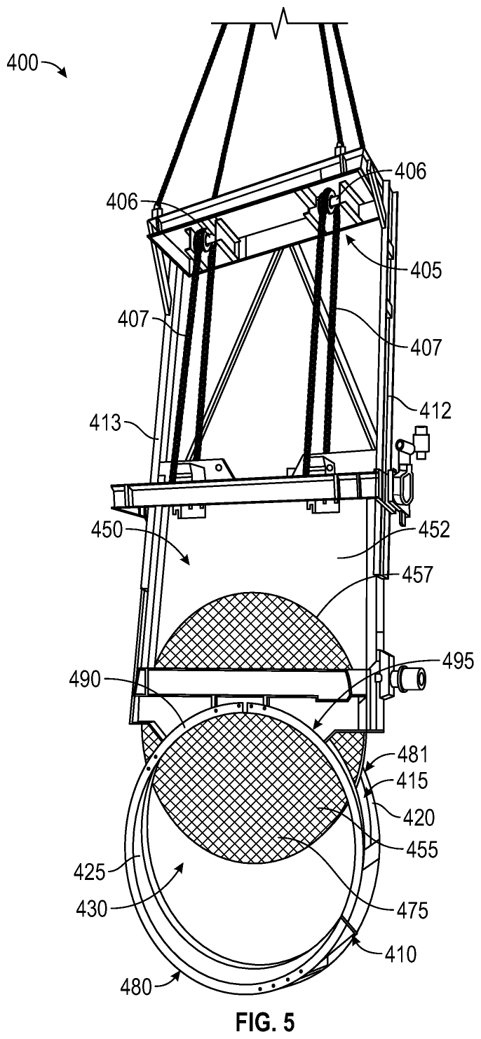

FIG. 5 depicts flue gas strainer apparatus 400 in a partially retracted position. As shown in FIG. 5, moveable strainer portion 450 and/or the one or more removable mesh portions 455 may be received in the receiving portion 415 of the housing 410 disposed between a front end 480 and a back end 481 of the housing 410. In some instances, receiving portion 415 may be a slot in the housing disposed between the front end 480 and back end 481 of the housing 410. The flue gas strainer apparatus 400 may also include one or more sealing elements operable to form a seal around the moveable strainer portion 450 and/or the one or more removable mesh portions 455 once received in the receiving portion 415.

As shown in FIG. 5, flue gas strainer apparatus 400 may include a means 405 for moving the moveable strainer portion 450 comprising the one or more removable mesh portions 455. The means for moving 405 the movable strainer portion 450 may be operable to move the strainer portion 450 such that the one or more removable mesh portions 455 disposed about the moveable strainer portion 450 may be retracted from the receiving portion 415 such that the one or more mesh portions 455 or a respective one of the one or more removable mesh portions of the moveable strainer portion 450 is removed from the inner bore 430 of the housing 410 to a position outside the inner bore 430 of the housing 410. The means for moving 405 the movable strainer portion 450 may also be operable to move the strainer portion 450 such that the one or more removable mesh portions 455 disposed about the moveable strainer portion 450 may be inserted into the receiving portion 415 such that the one or more mesh portions 455 or a respective one of the one or more removable mesh portions of the moveable strainer portion 450 is received in the inner bore 430 of the housing 410 after being inserted from a position outside the inner bore 430 of the housing 410. In some instances, the means for moving 405 the moveable strainer portion 450 may include a motor 406 coupled to one or more tethers 407 that are in turn coupled to the moveable strainer portion 450. The moveable strainer portion 450 may also include a support frame 452 coupling the one or more removable mesh portions 455 to the means for moving the moveable strainer portion 405. In at least some instances, the support frame 452 may be coupled to one or more edges of the one or more removable mesh portions 455, such as edge 457 shown in FIGS. 5 and 6. The support frame 452 may be operable to provide rigid support to the one or more removable mesh portions 455 as well as a means for coupling the one or more removable mesh portion 455 to one or more tethers 407. The support frame 452 may also be operable to engage one or more guide rails 412, 413 operable to slidingly receive the support frame 452 and/or moveable strainer portion 450. The one or more guide rails 412, 413 may be operable to support and guide the moveable strainer portion 450 and/or the one or more removable mesh portions 455 during retraction from or insertion into the receiving portion 415 of housing 410. While FIGS. 4-6 depict flue gas strainer apparatus 400 as having a cylindrical or circular geometry suited for positioning in cylindrical flue gas ducting or conduit, flue gas strainer apparatus 400 can have any geometry. In particular, flue gas strainer apparatus 400 may be constructed to have any geometry so that it may be adapted for use in flue gas ducting or conduit having any geometry.

Any number of flue gas strainer apparatuses may be employed in system 100 depicted in FIG. 1. In some instances, a single flue gas strainer apparatus 130 may be used in system 100. In such instances, operation of a single flue gas strainer apparatus 130 in the flowpath of the heated fluid may be sufficient to mitigate the fouling of the catalyst in the downstream catalytic reactor 150 and other downstream equipment according to the operational parameters of system 100. When a single flue gas strainer apparatus 130 is employed in system 100, solid particulates that may be suspended in heated fluid stream 125 will not be captured by flue gas strainer apparatus 130 when flue gas strainer apparatus 130 is being serviced or cleaned in the retracted configuration, such as retracted configuration 402 depicted in FIG. 6. In some instances, a plurality of flue gas strainer apparatuses, or two or more flue gas strainer apparatuses may be employed in system 100, such as flue gas strainer apparatuses 130, 140 depicted in FIG. 1. In such instances, the plurality of flue gas strainer apparatuses, such as first removable flue gas strainer apparatus 130 and second removable flue gas strainer apparatus 140, may be arranged in series such that one of the flue gas strainer apparatuses may be cleaned outside the flowpath of the heated fluid stream while the other flue gas strainer apparatus is operable to capture solid particulates suspended in the heated fluid stream, providing for continuous operation of system 100 without the need to cease operations to clean the one or more removable flue gas strainers 130, 140.

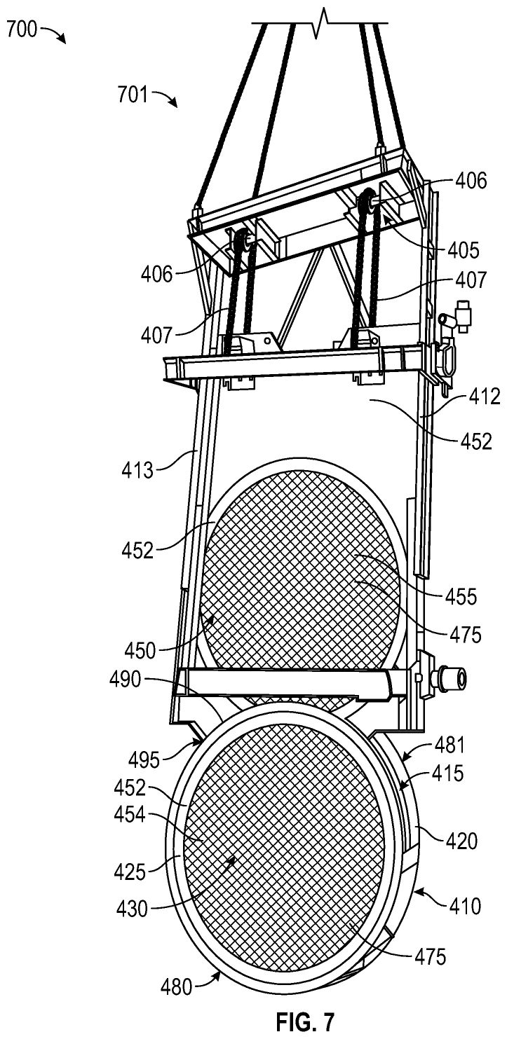

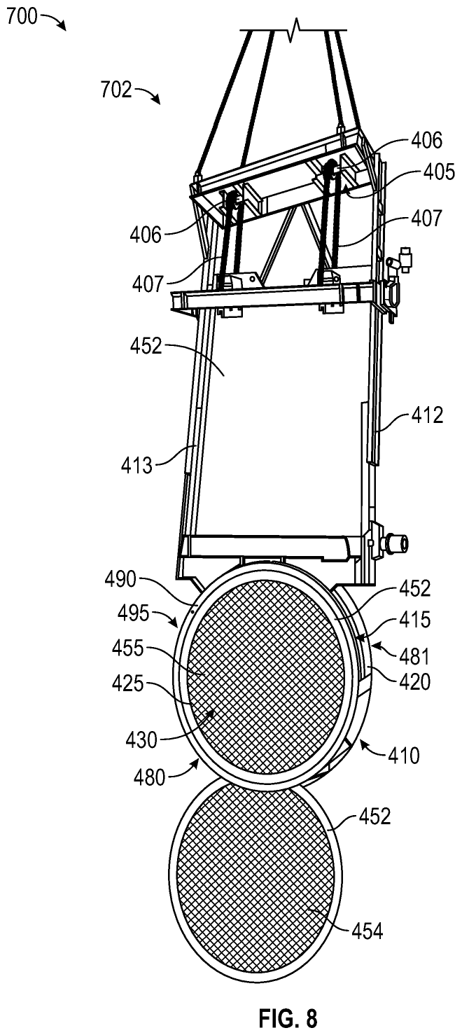

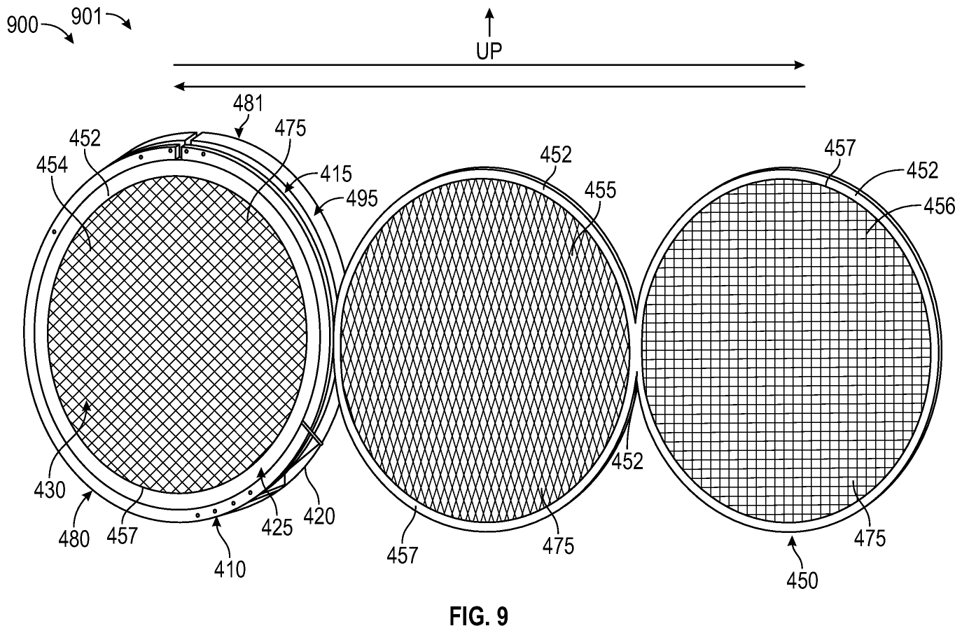

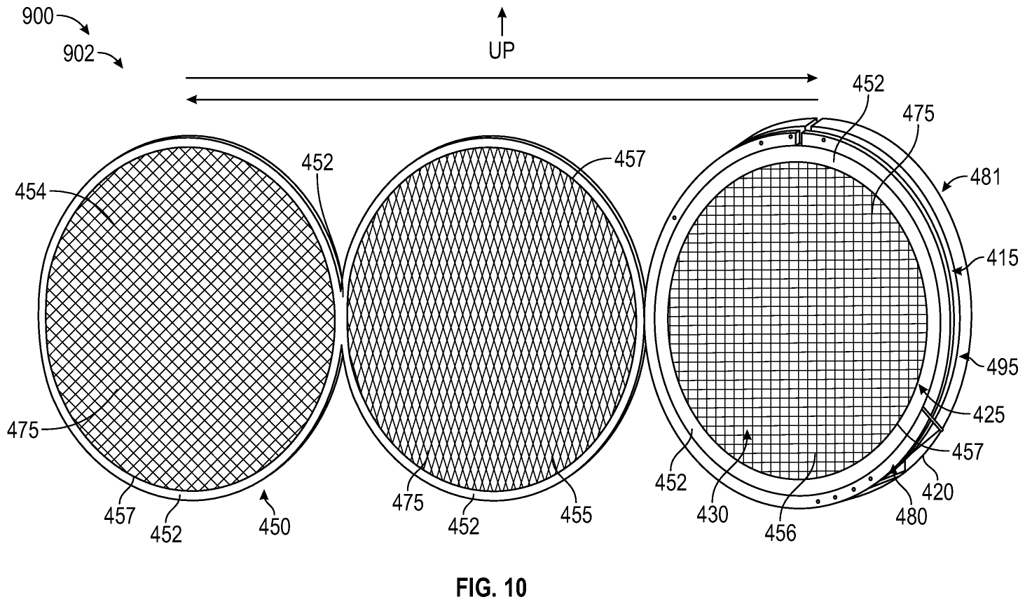

In other embodiments, system 100 and method 105 may include flue gas strainer apparatuses 130, 140 having a plurality of removable mesh portions, such as flue gas strainer apparatus 700 shown in FIGS. 7-8 and flue gas strainer apparatus 900 shown in FIGS. 9-10. In such embodiments, one of the plurality of removable mesh portions may be inserted into the heated fluid stream and operable to capture suspended solid particulates while one or more of the other removable mesh portions is simultaneously positioned outside the flowpath of the heated fluid stream and available to be cleaned or serviced. In this manner, the plurality of removable mesh portions on the same flue gas strainer apparatus 130, 140 may be rotated into and out of the flowpath of the heated fluid stream, as needed, without disrupting or ceasing flue gas flow or operations. In particular, system 100 and method 105 may include a means for moving 171, 172 the moveable strainer portions, and the one or more removable mesh portions thereon, of a respective one of flue gas strainer apparatuses 130, 140. The means for moving 171, 172 may be mechanically coupled with the moveable strainer portions of flue gas strainer apparatuses 130, 140 as well as communicatively coupled with controller 1102, as shown in FIG. 1.

In certain embodiments, system 100 and method 105 may further include one or more differential pressure sensors, such as differential pressure sensors 181, 182, 183, 184, operable to measure the pressure at a plurality of positions along the ducting of system 100. In particular, differential pressure sensors 181, 182, 183, 184 may be operable to measure pressure increases or decreases at positions along the ducting of system 100 that may be indicative of the reduced efficiency of one or more flue gas strainer apparatuses 130, 140 due to fouling of flue gas strainer apparatus 130, 140. Therefore, differential pressure sensors 181, 182, 183, 184 may be used by an operator of system 100 or a controller device to determine when one or more removable mesh portions of a flue gas strainer apparatus is fouled and in need of rotation or retraction from the flue gas ducting of system 100. Optionally, system 100 may include one or more optical sensor devices 191, 192 operable to optically inspect and monitor the fouling of the one or more removable mesh portions of a flue gas strainer apparatus 130, 140. As shown in FIG. 1, the differential pressure sensors 181, 182, 183, 184 and optical sensor devices 191, 192 may be communicatively coupled with controller 1102.

In certain embodiments, system 100 and method 105 may further include one or more cleaning devices 187, 188 coupled with flue gas strainer apparatus 130, 140. The one or more cleaning devices 187, 188 may be operable to clean the fouled one or more removable mesh portions by removing the solid particulates that have accumulated on the one or more removable mesh portions of flue gas strainer apparatus 130, 140. As shown in FIG. 1, the one or more cleaning devices 187, 188 may be communicatively coupled with controller 1102.

Method 105 of reacting a heated fluid stream with a catalytic reactor may employ system 100 or portions thereof. In particular, method 105 may include capturing solid particulates suspended in a heated fluid stream on or about one or more flue gas strainer apparatuses, such as flue gas strainer apparatuses 130, 140. The method 105 may also include removing the moveable strainer portion and/or the one or more removable mesh portions from the flowpath of the heated fluid stream without disrupting the flow of the heated fluid stream through the inner bore, and cleaning the retracted one or more removable mesh portions of the moveable strainer portion to substantially remove the captured solid particulates. Method 105 may also include re-inserting the moveable strainer portion and/or the one or more removable strainer portions into the flowpath of the heated fluid stream.

In an alternative embodiment, method 105 may include providing one or more flue gas strainer apparatuses, such as flue gas strainer apparatuses 130, 140, positioned in a flowpath of a heated fluid stream between one or more heating elements 120 and one or more catalytic reactors 150. Method 105 may also include capturing solid particulates suspended in the heated fluid stream on or about the one or more removable mesh portions 455 of the one or more flue gas strainer apparatuses 130, 140. Method 105 may also include removing the moveable strainer portion 450 and/or the one or more removable mesh portions 455 from the flowpath of the heated fluid stream without disrupting the flow of the heated fluid stream through the inner bore 410 of the flue gas strainer apparatus 130, 140. In such instances, method 105 may also include cleaning the one or more removable mesh portions 455 of the moveable strainer portion 450 to substantially remove the captured solid particulates and re-inserting the moveable strainer portion 450 and/or the one or more removable mesh portions 455 into the flowpath of the heated fluid stream.

In cases in which system 100 includes a plurality of flue gas strainer apparatuses 130, 140, method 105 may include deploying the first flue gas strainer apparatus 130 in the first received configuration 401 so as to cause the capture of solid particulates suspended in the heated fluid stream on or about the one or more removable mesh portions 455 of the first flue gas strainer apparatus 130. Method 105 may further include deploying the first flue gas strainer apparatus 130 in the second retracted configuration 402 while the second flue gas strainer apparatus 140 is deployed in the first received configuration 401. Method 105 may further include cleaning the one or more removable mesh portions 455 of the first flue gas strainer apparatus 130 so as to substantially remove the captured solid particulates and capturing solid particulates on or about the one or more removable mesh portions 455 of the second flue gas strainer apparatus 140 substantially contemporaneous with the cleaning of the one or more removable mesh portions 455 of the first flue gas strainer apparatus 130.

Method 105 may also include deploying, after substantial removal of the captured solid particulates from the one or more removable mesh portions 455, the first flue gas strainer apparatus 130 in the first received configuration 401 so as to cause the capture of solid particulates suspended in the heated fluid stream. Method 105 may then include deploying the second flue gas strainer apparatus 140 in the second retracted configuration 402 while the first flue gas strainer apparatus 130 is deployed in the first received configuration 401. Method 105 may then include cleaning the one or more removable mesh portions 455 of the second flue gas strainer apparatus 140 so as to substantially remove the captured solid particulates and capturing solid particulates on or about the one or more removable mesh portions 455 of the first flue gas strainer apparatus 130 substantially contemporaneous with the cleaning of the one or more removable mesh portions 455 of the second flue gas strainer apparatus 140.

Method 105 may also include conducting one or more refinery operations 110 to generate a flue gas stream 115. The method 105 may then include heating the flue gas stream 115 at one or more heating elements 120 to produce a heated flue gas stream 125. Method 105 may further include supplying the heated flue gas stream 125 to a first flue gas strainer apparatus 130 to generate a first strained flue gas stream 135. The method 105 may further include supplying the first strained flue gas stream 135 to a second flue gas strainer apparatus 140 to produce a second strained flue gas stream 145. The second flue gas stream 145 may then be supplied to one or more catalytic reactors 150 containing a catalyst or catalyst bed operable to treat the heated flue gas stream to produce a treated flue gas stream 155.

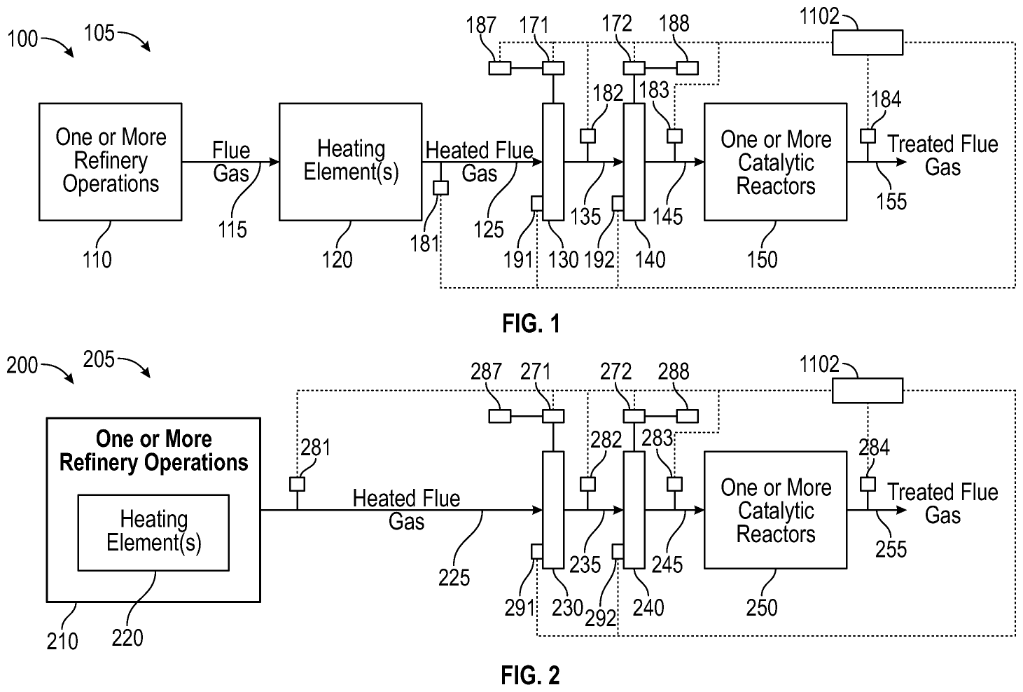

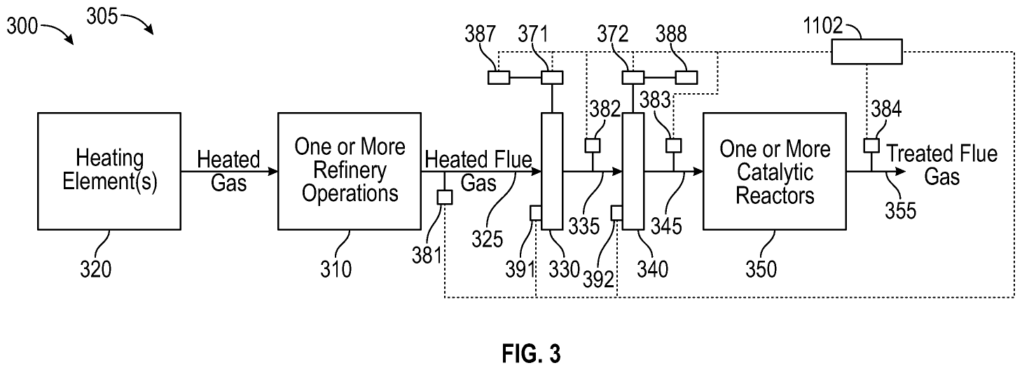

FIGS. 2 and 3 depict alternative embodiments of the presently disclosed systems and methods. In particular, system 200 and method 205, depicted in FIG. 2, involve a heated flue gas stream 225 that is generated by one or more refinery operations 210 employing one or more heating elements 220. Heated flue gas stream 225 may then be supplied to first flue gas strainer apparatus 230 and second flue gas strainer apparatus 240 to produce first strained flue gas stream 235 and second strained flue gas stream 245 in series. The second strained flue gas stream 245 may be supplied to one or more catalytic reactors 250 to produce treated flue gas stream 255. System 200 and method 205 may optionally further include one or more differential pressure sensors, such as differential pressure sensors 281, 282, 283, 284, operable to measure the pressure at a plurality of positions along the ducting of system 200, as well as optional one or more optical sensor devices 291, 292 operable to optically inspect and monitor the fouling of the one or more removable mesh portions of a flue gas strainer apparatus 230, 240. As shown in FIG. 2, the differential pressure sensors 281, 282, 283, 284 and optical sensor devices 291, 292 may be communicatively coupled with controller 1102. In at least some embodiments, the one or more catalytic reactors 250 employed in system 200 and method 205 may be part of a fluid catalytic cracking (FCC) unit.

System 200 and method 205 may include a means for moving 271, 272 the moveable strainer portions, and the one or more removable mesh portions thereon, of a respective one of flue gas strainer apparatuses 230, 240. The means for moving 271, 272 may be mechanically coupled with the moveable strainer portions of flue gas strainer apparatuses 230, 240 as well as communicatively coupled with controller 1102, as shown in FIG. 2.

In certain embodiments, system 200 and method 205 may further include one or more cleaning devices 287, 288 coupled with flue gas strainer apparatus 230, 240. The one or more cleaning devices 287, 288 may be operable to clean the fouled one or more removable mesh portions by removing the solid particulates that have accumulated on the one or more removable mesh portions of flue gas strainer apparatus 230, 240. As shown in FIG. 2, the one or more cleaning devices 287, 288 may be communicatively coupled with controller 1102.

System 300 and method 305, depicted in FIG. 3, involve the use of one or more heating elements 320 to heat a fluid stream to generate a heated fluid stream 305 that may be supplied to one or more refinery operations 310 resulting in heated flue gas stream 325. Heated flue gas stream 325 that was generated by one or more refinery operations 310 may then be supplied to first flue gas strainer apparatus 330 and second flue gas strainer apparatus 340 to produce first strained flue gas stream 335 and second strained flue gas stream 345 in series. The second strained flue gas stream 345 may be supplied to one or more catalytic reactors 350 to produce treated flue gas stream 355. System 300 and method 305 may optionally further include one or more differential pressure sensors, such as differential pressure sensors 381, 382, 383, 384, operable to measure the pressure at a plurality of positions along the ducting of system 300, as well as optional one or more optical sensor devices 391, 392 operable to optically inspect and monitor the fouling of the one or more removable mesh portions of a flue gas strainer apparatus 330, 340. In at least some embodiments, the one or more catalytic reactors 350 employed in system 300 and method 305 may be part of a fluid catalytic cracking (FCC) unit.

System 300 and method 305 may include a means for moving 371, 372 the moveable strainer portions, and the one or more removable mesh portions thereon, of a respective one of flue gas strainer apparatuses 330, 340. The means for moving 371, 372 may be mechanically coupled with the moveable strainer portions of flue gas strainer apparatuses 330, 340 as well as communicatively coupled with controller 1102, as shown in FIG. 3.

In certain embodiments, system 300 and method 305 may further include one or more cleaning devices 387, 388 coupled with flue gas strainer apparatus 330, 340. The one or more cleaning devices 387, 388 may be operable to clean the fouled one or more removable mesh portions by removing the solid particulates that have accumulated on the one or more removable mesh portions of flue gas strainer apparatus 330, 340. As shown in FIG. 3, the one or more cleaning devices 387, 388 may be communicatively coupled with controller 1102.

The presently disclosed flue gas strainer apparatuses 400, 700, 900, as well as methods 105, 205, 305, and systems 100, 200, 300 employing the flue gas strainer apparatus 400, 700, 900, are operable to prevent or reduce fouling of downstream catalysts and equipment from solid particulates that may be derived from upstream heating elements. In at least some instances, the one or more heating elements may be a refractory heating element or a fiber refractory heating element. In order to provide optimum protection for downstream catalysts the one or more removable mesh portions 455 of the flue gas strainer apparatus 400 may be sized based on the catalyst that it is protecting. In general, removable mesh portions 455 having an average pore size that is smaller than the average pore size of the catalyst are desirable. In certain embodiments, the mesh size of the one or more removable mesh portions, such as mesh portion 455, may be from about 1 mm to about 7 mm, or from about 0.5 mm to about 10 mm, or from about 1 mm to about 5 mm, or from about 2.5 mm to about 5 mm, or from about 3 mm to about 5 mm, or from about 0.5 mm to about 5 mm.

FIG. 7 is a schematic representation of a dual element flue gas strainer apparatus 700 having two removable mesh portions 454, 455 for removing solid particulates from a heated fluid stream. As depicted in FIG. 7, flue gas strainer apparatus 700 is shown in a first configuration 701 with a first removable mesh portion 454 received in the receiving portion 415 of the housing 410 and a second removable mesh portion 455 positioned outside the housing. In FIG. 8, the dual element flue gas strainer apparatus 700 is shown in a second configuration 702 with the second removable mesh portion 455 received in the housing and the first removable mesh portion 454 positioned outside the housing 410 so that it may be cleaned.

FIG. 9 is a schematic representation of a three element flue gas strainer apparatus 900 having three removable mesh portions 454, 455, 456 for removing solid particulates from a heated fluid stream. As shown in FIG. 9, flue gas strainer apparatus 900 is shown in a first configuration 901 with a first removable mesh portion 454 received in the receiving portion 415 of housing 410 and a second 455 and third 456 removable mesh portions positioned outside the housing 410 so that they may be cleaned. In FIG. 10, the three element flue gas strainer apparatus 900 is shown in a second configuration 902 in which the first removable mesh portion 454 and the second removable mesh portion 455 is positioned outside the housing 410 in a cleaning position while the third removable mesh portion 456 is received in the receiving portion 415 of housing 410.

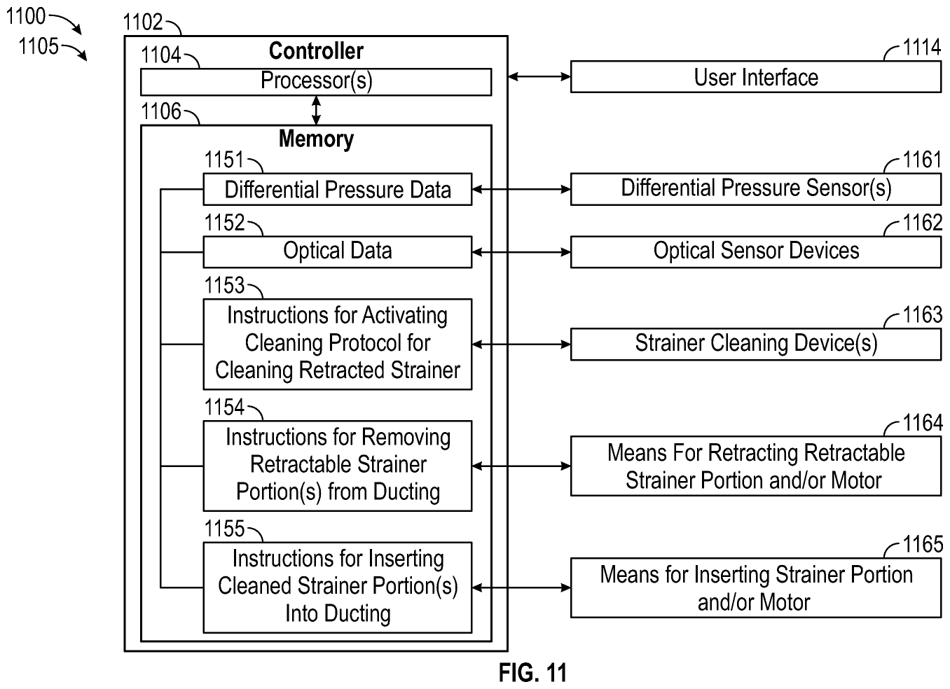

FIG. 11 is a graphical representation of a flue gas strainer insertion/retraction control system 1100 and method 1105 for inserting and/or retracting one or more removable mesh portions with respect to a flue gas strainer housing or flue gas ducting, according to an exemplary embodiment of the present disclosure. Systems 100, 200, 300, depicted in FIGS. 1-3, may include a controller 1102 that may be implemented as part of flue gas strainer insertion/retraction control system 1100 and method 1105, according to the exemplary embodiments of flue gas strainer insertion/retraction control system 1100 and method 1105 provided in FIG. 11. Insertion/retraction control system 1100 may control the movement of the moveable strainer portion and the insertion and retraction of the one or more removable mesh portions from the receiving portion of the housing of one or more flue gas strainer apparatuses in systems 100, 200, 300. Other embodiments of insertion/retraction control systems are within the spirit and scope of the present disclosure.

As depicted in FIG. 11, insertion/retraction control system 1100 may include a controller 1102. Controller 1102 may comprise one or more controllers, a programmable logic controller (PLC), a supervisory control and data acquisition (SCADA) system, a computing device, and combinations thereof, as well as other components, to manage or control the movement of the moveable strainer portion and/or the insertion and/or the retraction of the one or more removable mesh portions of one or more flue gas strainer apparatuses into and from the flue gas strainer housing or flue gas ducting. Controller 1102 may include one or more processors (e.g., processor 1104) to execute instructions stored in memory 1106. In an exemplary embodiment, the memory 1106 may be a machine-readable storage medium. As used herein, a “machine-readable storage medium” may be any electronic, magnetic, optical, or other physical storage apparatus to contain or store information such as executable instructions, data, and the like. For example, any machine-readable storage medium described herein may be any of random access memory (RAM), volatile memory, non-volatile memory, flash memory, a storage drive (e.g., hard drive), a solid state drive, any type of storage disc, and the like, or a combination thereof. As noted, the memory 1106 may store or include instructions executable by processor 1104. As used herein, a “processor” may include, for example one processor or multiple processors included in a single device or distributed across multiple computing devices. The processor 1104 may be at least one of a central processing unit (CPU), a semiconductor-based microprocessor, a graphics processing unit (GPU), a field-programmable gate array (FPGA) to retrieve and execute instructions, a real time processor (RTP), other electronic circuitry suitable for the retrieval and execution of instructions stored on a machine-readable storage medium, or a combination thereof.

Instructions stored in the memory 1106 and executable by the processor 1104 may include instructions 1154 to remove or retract the movable strainer portion and/or the one or more removable mesh portions from the housing or flue gas ducting by moving or retracting the movable strainer portion. Controller 1102 may control the means 1164 for moving strainer portion and retracting one or more removable mesh portions based on instructions 1154 for removing or retracting one or more removable mesh portions from the housing or flue gas ducting. The means for removing or retracting 1164 may include, for example, a motor 406 coupled to one or more tethers 407 that are in turn coupled to the moveable strainer portion 450 in systems 400, 700 depicted in FIGS. 4-8.

Similarly, memory 1106 may include instructions 1155 for moving the moveable strainer portion of one or more flue gas strainer apparatuses such that one or more removable mesh portions are inserted into the housing of the apparatus or inserted into the flowpath of the flue gas ducting. Controller 1102 may control the means 1165 for moving the strainer portion and thereby causing the insertion of one or more removable mesh portions into the housing or flue gas ducting. The means for removing or retracting 1165 may include, for example, a motor 406 coupled to one or more tethers 407 that are in turn coupled to the moveable strainer portion 450 in systems 400, 700 depicted in FIGS. 4-8. In at least some embodiments, the one or more removable mesh portions that may be inserted by controller 1102 may have been cleaned of solid particulates prior to being inserted. In certain embodiments, memory 1106 may include instructions 1153 for activating a cleaning protocol for cleaning one or more of the retracted removable mesh portions that have been retracted from the housing and/or the flue gas duct. In such embodiments, controller 1102 may control one or more strainer cleaning devices 1163 based on instructions 1153 for activating cleaning protocol or for cleaning retracted strainer. For example, one or more strainer cleaning devices 1163 may be mesh cleaning devices 187, 188 of system 100 depicted in FIG. 1 or mesh cleaning devices 287, 288 in system 200 depicted in FIG. 2 or mesh cleaning devices 387, 388 in system 300 depicted in FIG. 3.

Memory 1106 of controller 1102 may also include differential pressure data 1151 obtained from differential pressure sensors 1161, such as differential pressure sensors 181, 182, 183, 184 in system 100 depicted in FIG. 1, or differential pressure sensors 281, 282, 283, 284 in system 200 depicted in FIG. 2, or differential pressure sensors 381, 382, 383, 384 in system 300 depicted in FIG. 3. In certain embodiments, memory 1106 may also optionally include optical data 1152 obtained from one or more optical sensor devices 1162, such as optical sensor devices 191, 192 in system 100 depicted in FIG. 1, or optical sensor devices 291, 292 in system 200 depicted in FIG. 2, or optical sensor devices 391, 392 in system 300 depicted in FIG. 3. In certain embodiments, controller 1102 may determine when one or more of removable mesh portions are fouled by captured solid particulates based on data 1151, 1152 obtained from differential pressure sensors 1161 and/or optical sensor devices 1162. Insertion/retraction control system 1100 may also include a user interface 1114 operable to manually communicate with the controller 1102 to manually control any of the above-described functions of controller 1102 or to manually input data into memory 1106, or to override any of the instructions stored in memory 1106.

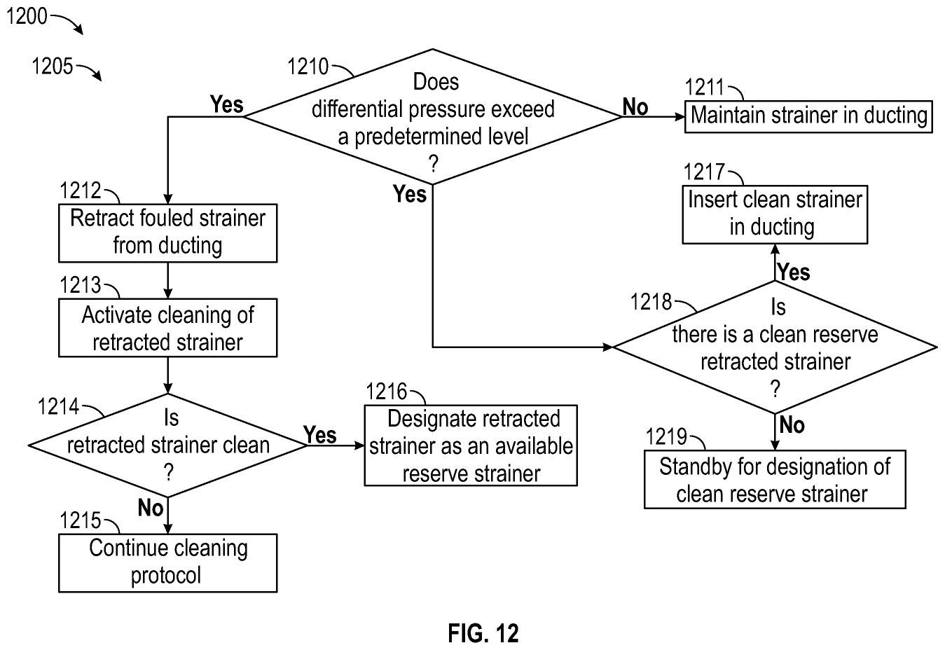

FIG. 12 is a flow diagram of controller operations in a flue gas strainer insertion/retraction control system 1100 and method 1105 for inserting and/or retracting one or more removable mesh portions with respect to a flue gas strainer housing or flue gas ducting, according to an exemplary embodiment of the present disclosure. The flow diagram shown in FIG. 12, depicts a method 1200 and system 1205 for inserting and/or retracting one or more removable mesh portions, such as may be implemented by controller 1102, according to an exemplary embodiment of the present disclosure. Method 1200 and system 1205 is detailed with reference to the controller 1102 and injection control system 1100 of FIG. 11. Unless otherwise specified, the actions of method 1200 may be completed, in an exemplary embodiment, within the controller 1102, but may also be implemented in other systems and/or computing devices as will be understood by those skilled in the art. Specifically, method 1200 may be included in one or more programs, protocols, or instructions loaded into the memory 1106 of the controller 1102 and executed on the processor 1104 or one or more processors of the controller 1102. The order in which the operations are described is not intended to be construed as a limitation, and any number of the described blocks may be combined in any order and/or in parallel to implement the method 1200.

At block 1210, controller 1102 may determine whether a change in the differential pressure in the system, such as systems 100, 200, 300 depicted in FIGS. 1-3, exceeds a predetermined level. In some embodiments, the controller 1102 may alternatively determine at block 1210 whether the pressure or differential pressure measured at one or more pressure sensors exceeds a predetermined level. In certain other embodiments, the controller 1102 may alternatively determine at block 1210 whether the pressure or differential pressure measured at one or more pressure sensors falls below a certain pressure level. Such a determination by controller 1102 may be made based on, for example, data received from differential pressure sensors 181, 182, 183, 184 of system 100 depicted in FIG. 1 or differential pressure sensors 281, 282, 283, 284 of system 200 depicted in FIG. 2, or differential pressure sensors 381, 382, 383, 384 of system 300 depicted in FIG. 3. If the controller 1102 determines at block 1210 that the measured pressure or change in differential pressure exceeds or falls below a predetermined level, the controller 1102 may retract one or more fouled strainers or meshes from the ducting at block 1212. Controller 1102 may also activate at block 1213 one or more cleaning protocols or cleaning devices to clean the accumulated solid particulates from the retracted one or more removable mesh portions. For example, controller 1102 may activate at block 1213 one or more of cleaning devices 187, 188 in system 100 depicted in FIG. 1, or cleaning devices 287, 288 in system 200 depicted in FIG. 2, or cleaning devices 387, 388 in system 300 depicted in FIG. 3.

At block 1214, controller 1102 may determine whether the retracted mesh portion or moveable strainer portion is clean. If the controller 1102 determines at block 1214 that the retracted mesh portion or moveable strainer portion is clean, controller 1102 may designated at block 1216 the retracted mesh portion or moveable strainer portion as an available reserve mesh portion or moveable strainer portion that may be re-inserted into the housing or into the flue gas ducting. If the controller 1102 determines at block 1214 that the retracted mesh portion or moveable strainer portion is not clean, then controller 1102 may at block 1215 instruct the cleaning devices to continue the cleaning protocol until the controller determines that the retracted moveable strainer portion or mesh portion is substantially clean of accumulated solid particulates.

If the controller 1102 determines at block 1210 that the measured pressure or change in pressure exceeds or falls below a predetermined level, the controller may also determine at block 1218 whether there is a clean reserve retracted mesh portion or moveable strainer portion. If the controller 1102 determines at block 1218 that there is clean retracted reserve mesh portion or moveable strainer portion, the controller 1102 may at block 1217 instruct the means of moving the moveable strainer portion to move such that a clean mesh portion is inserted into the housing or flue gas ducting. If the controller 1102 determines at block 1218 that there is not a clean retracted reserve mesh portion or moveable strainer portion available, the controller 1102 will at block 1219 standby for the designation of an available clean reserve strainer, such as by designation at block 1216. If at block 1210, the controller 1102 determines that the measured pressure or differential pressure does not exceed or fall below a predetermined level, the controller at block 1211 will maintain the removable mesh portion and/or the moveable strainer portion in the housing or flue gas ducting.

As used herein, the term “transmits a signal,” or reference to other signal communications, in all their forms, refers to electric communication such as hard wiring two components together or wireless communication, as understood by those skilled in the art. For example, wireless communication may be Wi-Fi®, Bluetooth®, ZigBee, forms of near field communications, or other wireless communication methods as will be understood by those skilled in the art. In addition, “transmits a signal” and other signal communications may involve or include one or more intermediate controllers, relays, or switches disposed between elements that are in signal communication with one another.

When ranges are disclosed herein, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, reference to values stated in ranges includes each and every value within that range, even though not explicitly recited. Thus, every point or individual value may serve as its own lower or upper limit combined with any other point or individual value or any other lower or upper limit, to recite a range not explicitly recited.

This application claims priority to, and the benefit of, U.S. Provisional Application No. 63/386,586, filed Dec. 8, 2022, titled “Removable Flue Gas Strainer and Associated Methods,” the disclosure of which is incorporated herein by reference in its entirety.

Other objects, features and advantages of the disclosure will become apparent from the foregoing figures, detailed description, and examples. It should be understood, however, that the figures, detailed description, and examples, while indicating specific embodiments of the disclosure, are given by way of illustration only and are not meant to be limiting. In further embodiments, features from specific embodiments may be combined with features from other embodiments. For example, features from one embodiment may be combined with features from any of the other embodiments. In further embodiments, additional features may be added to the specific embodiments described herein.

1. A flue gas strainer apparatus comprising:
a housing having a front end and a back end, the housing comprising a receiving portion, an outer edge, an inner edge, and an inner bore extending from the front end to the back end of the housing along the inner edge, the inner bore positioned to allow a heated flue gas stream to pass therethrough;
a moveable strainer portion comprising one or more removable mesh portions having a plurality of pores and configured to capture solid particulates suspended in the heated flue gas stream, the one or more removable mesh portions operable to be removingly received in the receiving portion of the housing such that:
in a first received configuration, the one or more removable mesh portions is operable to capture solid particulates suspended in the heated flue gas stream passing through the inner bore of the housing, and
in a second retracted configuration, the one or more removable mesh portions is operable to be retracted such that the one or more removable mesh portions is outside the inner bore of the housing and operable to be cleaned of captured solid particulates while the heated flue gas stream continues to flow through the inner bore of the housing;
a first sensor positioned downstream of the moveable strainer portion and configured to measure a first characteristic;
a second sensor positioned upstream of the moveable strainer portion and configured to measure a second characteristic; and
a controller in signal communication with the first sensor and the second sensor, the controller configured to:
obtain the first characteristic and the second characteristic, and
based on the first characteristic and the second characteristic, move one or more of the one or more removable mesh portions from one of (a) the first received configuration to the second retracted configuration or (b) the second retracted configuration to the first received configuration.

2. The flue gas strainer apparatus according to claim 1, further comprising one or more sealing elements connected to the outer edge of the housing, the one or more sealing elements operable to sealingly engage a duct containing the heated flue gas stream.

3. The flue gas strainer apparatus according to claim 2, wherein the one or more sealing elements comprises one or more flanges operable to sealingly engage the duct containing the heated flue gas stream.

4. The flue gas strainer apparatus according to claim 3, further comprising a motor coupled with the moveable strainer portion configured to (a) retract the moveable strainer portion from the receiving portion such that the one or more removable mesh portions of the moveable strainer portion is removed from the inner bore of the housing to a position outside the inner bore of the housing, and (b) advance the moveable strainer portion such that the one or more removable mesh portions of the moveable strainer portion is inserted into the inner bore of the housing from a position outside the inner bore of the housing.

5. The flue gas strainer apparatus according to claim 4, wherein the motor connects to the moveable strainer portion by one or more of: (a) one or more tethers or (b) a pully apparatus.

6. The flue gas strainer apparatus according to claim 5, wherein the moveable strainer portion comprises a support frame connecting the one or more removable mesh portions to the motor.

7. The flue gas strainer apparatus according to claim 6, wherein the support frame is connected to one or more edges of the one or more mesh portions.

8. The flue gas strainer apparatus according to claim 6, wherein the moveable strainer portion further comprises a plurality of removable mesh portions.

9. The flue gas strainer apparatus according to claim 8, wherein the plurality of removable mesh portions is connected to the support frame, the removable mesh portions are positioned spaced-apart on the support frame or on the moveable strainer portion, such that when at least one mesh portion is inserted into the inner bore of the housing, at least one other mesh portion is positioned outside the inner bore of the housing.

10. The flue gas strainer apparatus according to claim 9, wherein the motor is configured to cycle the plurality of removable mesh portions into and out of the inner bore of the housing such that when a fouled mesh portion comprising captured particles is removed from the inner bore of the housing, a clean mesh portion is inserted into the inner bore of the same housing by the same motion of the moveable strainer portion.

11. The flue gas strainer apparatus according to claim 1, wherein the receiving portion comprises a slot in the housing disposed between the front end and the back end of the housing.

12. The flue gas strainer apparatus according to claim 11, further comprising one or more guide rails operable to slidingly receive the moveable strainer portion, or a portion thereof, the one or more guide rails operable to support and guide the moveable strainer portion during retraction or insertion.

13-30. (canceled)

31. The flue gas strainer apparatus according to claim 1, wherein the first sensor and the second senor each comprises a pressure sensor to measure pressure of the heated flue gas stream, wherein the first characteristic is a downstream pressure of the heated flue gas stream and the second characteristic is an upstream pressure of the heated flue gas stream, wherein the controller is further configured to determine a pressure differential of the downstream pressure and the upstream pressure, and wherein movement of one or more of the one or more removable mesh portions is based on the pressure differential.

32. The flue gas strainer apparatus according to claim 1, wherein first sensor and the second senor each comprises an optical sensor device, and wherein the first characteristic and the second characteristic comprises a level of fouling of the one or more removable mesh portions.

33. A flue gas strainer apparatus comprising:
a housing having a front end and a back end, the housing comprising two or more receiving portions, an outer edge, an inner edge, and an inner bore extending from the front end to the back end of the housing along the inner edge, the inner bore positioned to allow a heated flue gas stream to pass therethrough;
two or more moveable strainer portions each comprising a mesh portion having a plurality of pores and configured to capture solid particulates suspended in the heated flue gas stream, the mesh portion operable to be removingly received in one of the two or more receiving portions of the housing such that:
in a first configuration, the mesh portion resides within the inner bore of the housing and captures solid particulates suspended in the heated flue gas stream passing therethrough, and
in a second configuration, the mesh portion resides external to the housing;
a first sensor positioned downstream of the two or more moveable strainer portions and configured to measure a first characteristic;
a second sensor positioned upstream of the two or more moveable strainer portions and configured to measure a second characteristic; and
a controller in signal communication with the first sensor and the second sensor, the controller configured to:
obtain the first characteristic and the second characteristic, and
based on the first characteristic and the second characteristic, move one or more of the two or more moveable strainer portions from one of (a) the first configuration to the second configuration or (b) the second configuration to the first configuration.

34. The flue gas strainer apparatus according to claim 33, wherein the controller is further configured to, when a first of the two or more moveable strainer portions is moved from the first configuration to the second configuration, move a second of the two or more moveable strainer portions from the second configuration to the first configuration.

35. The flue gas strainer apparatus according to claim 33, wherein a position of each of the two or more moveable strainer portions comprises a series format in relation to each other of the two or more moveable strainer portions.

36. The flue gas strainer apparatus according to claim 33, wherein the two or more moveable strainer portions comprise two moveable strainer portions, and further comprising a third sensor positioned between a first of the two moveable strainer portions and a second of the two moveable strainer portions and configured to measure a third characteristic.

37. A flue gas strainer apparatus comprising:
a housing having a front end and a back end, the housing comprising a receiving portion, an outer edge, an inner edge, and an inner bore extending from the front end to the back end of the housing along the inner edge, the inner bore positioned to allow a heated flue gas stream to pass therethrough;
a moveable strainer portion comprising one or more mesh portions having a plurality of pores and configured to capture solid particulates suspended in the heated flue gas stream, the one or more mesh portions operable to be removingly received in the receiving portion of the housing such that:
in a first configuration, one or more of the one or more mesh portions reside within the inner bore of the housing and captures solid particulates suspended in the heated flue gas stream passing therethrough, and
in a second configuration, one or more of the one or more mesh portions reside external to the housing;
a first pressure sensor positioned downstream of the moveable strainer portion and configured to measure a downstream pressure of the heated flue gas stream;
a second pressure sensor positioned upstream of the moveable strainer portion and configured to measure an upstream pressure of the heated flue gas stream; and
a controller in signal communication with the first pressure sensor and the second pressure sensor, the controller configured to:
obtain the downstream pressure and the upstream pressure,
determine a pressure differential based on the downstream pressure and the upstream pressure, and
based on the differential pressure, move one or more of the one or more mesh portions from one of (a) the first configuration to the second configuration or (b) the second configuration to the first configuration.

38. The flue gas strainer apparatus according to claim 37, further comprising a motor connected to the one or more mesh portions, wherein the controller is in signal communication with the motor, and wherein the controller moves the one or more mesh portions via a signal transmitted to the motor indicative of movement of one of the one or more mesh portions.
